(19) United States
(12) Patent Application Publication
(10) Pub. No.: US 2008/0179944 A1
(43) Pub. Date: Jul. 31, 2008

(54) Hydraulic anti-lock brake system

(75) Inventor: Rolf Spaeth, Bloomfield Hills, MI (US)

Correspondence Address: CONTINENTAL TEVES, INC., ONE CONTINENTAL DRIVE, AUBURN HILLLS, MI, 48326-1581, US

(73) Assignee: Continental Teves, Inc.

(21) Appl. No.: 11/699,132

(22) Filed: Jan. 29, 2007

(51) Int. Cl. B60T 8/34; B60T 7/12

(52) U.S. Cl. 303/113.1; 701/75

(57) ABSTRACT

In a hydraulic brake system with anti-lock control, noise is reduced during ABS control by controlling the flow rate of high-pressure fluid from the master brake cylinder (2) to the wheel brakes (15, 16). This is accomplished by placing an analog or pulse-width modulated NO valve (40) in the brake line between the connection of the pressure side of the hydraulic pump (35) and the inlet valve (20,27) to the wheel brake. By this means, only one analog or analogized valve is needed per brake circuit as opposed to two if the inlet valves were analog valves. In brake systems with traction control or electronic stability control, a shut-off valve is already present in this location. Thus replacing the existing valve with an analog or quasi-analog valve is easy. In substitution for the non-return valve usually arranged in parallel to the shut-off valve, the shut-off valve will be electronically opened when a pressure sensor (41) detects a situation in which the fluid path from the master brake cylinder (2) to the inlet valve (20.27) needs to be unrestricted.

### BACKGROUND OF THE INVENTION

The present invention relates to a hydraulic brake system with brake slip control, with a master brake cylinder which is connected to a pressure fluid reservoir, at least one wheel brake, a brake line from the master brake cylinder to the wheel brake, an inlet valve in the brake line, a low-pressure accumulator, a return line from the wheel brake cylinder to the low-pressure accumulator, an outlet valve in the return line, a hydraulic pump with an inlet side and a pressure side, a shut-off valve in the brake line between the master brake cylinder and the inlet valve, a pressure line from the pressure side of the hydraulic pump to the brake line between the shut-off valve and the inlet valve, a suction line from the low-accumulator to the inlet side of the hydraulic pump.

During brake slip control, i.e. during anti-lock brake control, the inlet valve will shut the fluid connection between the master brake cylinder and the wheel brake. Pressure fluid released from the wheel brake into the low-pressure accumulator will be returned by the hydraulic pump into the brake line. When the ABS algorithm reaches a pressure build-up phase, the inlet valve will open again to allow the high-pressure fluid from the brake line to progress into the wheel brake. These cycles take place at a high frequency. Due to the large volume of pressurized fluid displaced by the master brake cylinder pistons, the wheel brake makes knocking noises when the inlet vale opens, and the brake pedal pulsates due to the opening an closing of the inlet valve.

To improve the driver's comfort during such an anti-lock brake control regarding noise and pulsating pedal, the previously digital electromagnetically operated, normally open (NO), inlet valves have been replaced with analog valves or with quasi-analog valves. Quasi-analog valves are digital valves whose flow rate is controlled by pulse-width modulation. Due to this measure, the influx of high-pressure fluid into the wheel brakes is metered, thereby reducing noise and pulsation.

Since every electronically operated hydraulic brake system has four inlet valves, such a system requires four analog or quasi-analog valves. Compared to simple digital valves, this constitutes a significant increase in costs.

It is therefore an objective of the present invention to reduce the noise during Anti-lock control in a cost-effective way.

### SUMMARY OF THE INVENTION

This objective is achieved by placing an analog or quasi-analog shut-off valve in the brake line between the master brake cylinder and the pressure side of the hydraulic pump. During an anti-lock brake operation, the shut-off valve will be set to allow only a reduced flow rate from the master brake cylinder to the inlet valves.

Hydraulic brake systems which, in addition to anti-lock brake control, are also capable of active brake control without driver initiated braking, i.e. of traction control and/or electronic stability control, are already equipped with a shut-off valve in the described position. In such brake systems, no additional valves are necessary. The four inlet valves (two per brake circuit) can be simple digital NO valves and don't require any throttling function. Instead, two analog or quasi-analog valves (one per brake circuit) in the location of the shut-off valves will control the flow-rate from the master brake cylinder to the inlet valves.

Usually, the shut-off valves present in traction-controlled or stability-controlled brake systems are bypassed by non-return valves allowing a flow of pressure fluid from the master brake cylinder to the wheel brakes in the event that the driver of the vehicle presses the brake pedal and intends to slow down the vehicle. These non-return valves will be eliminated. Their function can be performed electronically with the help of pressure sensors measuring the pressure of the master brake cylinder chambers. If during an active braking operation the driver initiates a braking operation, the pressure sensors will detect this and inform the electronic controller of the brake system. The electronic controller will in turn switch the shut-off valve into its fully opened position.

While the shut-off valves controls the flow rate from the master brake cylinder to the wheel brake but not from the hydraulic pump to the wheel brake, this is of no negative consequence. The hydraulic pump is capable of building up a high pressure, but it has a small capacity and will replenish fluid rather slowly. Accordingly, while a high pressure may prevail at the inlet valves while they are closed, due to the small volume and the low pump capacity, this pressure will immediate decrease as soon as the inlet valves open. The volume taken up by the wheel brakes cannot be instantly replaced by the hydraulic pump nor by the master brake cylinder, whose connection to the wheel brake is throttled by the shut-off valve, resulting in a lower initial pressure in the wheel brakes that will not cause the brake pistons to knock. Due to the throttled fluid flow from the master brake cylinder, the pulsation of the brake pedal will be greatly reduced if not eliminated.

The invention will be illustrated in further detail by means of an embodiment shown in the accompanying drawing.

### BRIEF DESCRIPTION OF THE DRAWING

In the drawing,

FIG. 1 shows a simple set-up of an electronically controlled hydraulic brake system capable of active braking;

### DETAILED DESCRIPTION OF THE DRAWINGS

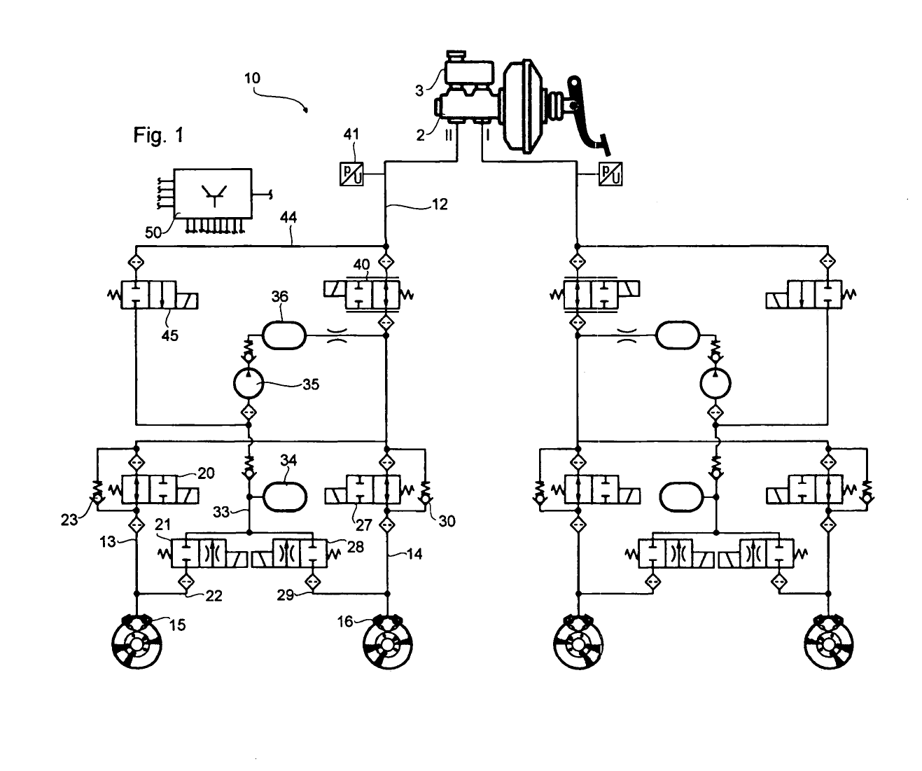

FIG. 1 shows a hydraulic dual-circuit brake system 1 for motor vehicles capable of performing anti-lock brake control as well as active interventions for traction control, ESC, and the like. While the invention is explained by means of this brake system, the active brake control functions are not necessary for the invention to work. The example has only been chosen because brake systems capable of active brake control already include shut-off valves in the brake lines, while these shut-off valves would have to be added to a pure anti-lock brake system.

The brake system 1 has a pedal-actuable tandem master brake cylinder 2 with a brake fluid reservoir 3.

Both brake circuits of the shown brake system have the same set-up, so that the following description of brake circuit II applies to brake circuit I as well.

The brake line 12 of brake circuit II begins at the master brake cylinder 2 and splits into two inlet lines 13 and 14. Inlet line 13 leads to a wheel brake 15 and inlet line 14 leads to a wheel brake 16 of a driven rear axle of the vehicle.

A valve assembly that comprises an inlet valve 20 disposed in the inlet line 13 and a outlet valve 21 that is located in a return line 22 is associated with the wheel brake 15. The inlet valve 20 has a spring-actuated open position and an electromagnetically switchable blocking position. The outlet valve 21 has a spring-actuated blocking position and an electromagnetically switchable open position. A one-way valve 23 is disposed in the inlet line 13 parallel to the inlet valve 20. The two-position valves 20 and 21 of the valve assembly also serve the purpose of brake pressure modulation; in switching positions and, a brake pressure build-up is possible in the wheel brake 15, while in the switching positions and, pressure holding and in switching positions and pressure reduction in wheel brake 15 are possible.

A valve assembly is likewise associated with the wheel brake 16 and in the same way as the valve assembly associated with wheel brake 15 comprises an inlet valve 27 in the inlet line 14 and a outlet valve 28 in a return line 29. A one-way valve 30 is connected parallel to the inlet valve 27 in the inlet line 14. The two-position valves 27 and 28 of the valve assembly 26 again have the purpose of modulating the brake pressure in the wheel brake 16.

The return lines 22 and 29 originating at the inlet lines 13 and 14 between the two-position valves 20 and 27 and the wheel brakes 15 and 16 are united in a return line 33 that is connected to the brake line 12. A low-pressure accumulator 34 communicates with the return line 33. Essentially disposed downstream of the low-pressure accumulator 34 in the return line 33 are a pump 35, a damper chamber 36 and a throttle. The pump 35 is a self-priming pump.

A shut-off valve 40 is disposed in the brake line 12 between the master brake cylinder 2 and the connection of the return line 33. The shut-off valve 40 has a spring-actuated open position and an electromagnetically actuated analog control adjusting the valve opening between the fully open and a completely closed position. Between the tandem master brake cylinder 2 and the shut-off valve 40, a pressure sensor 41 is arranged in the brake line, which detects whether the tandem master brake cylinder 2 is pressurized.

A bypass line 44 begins at the brake line 12 between the master brake cylinder 2 and the shut-off valve 40. Disposed in the bypass line 44 is a switch-over valve 45 having one spring-actuated or in other words currentless closed position and one electromagnetically switchable open position. The bypass line 44 is connected to the return line 33.

The inlet side of the self-priming pump 35 is connected to the return line 33 and thus to the bypass line 44.

The brake system 1 includes an electronic controller 50, in which signals from various sensors (not shown) that monitor the rotational behavior of the vehicle can be evaluated. The controller 50 controls the pump 35 and valves 20, 21, 27, 28, 40, 45 in accordance with a situation-specific control algorithm and, in the event that the demands of two control algorithms are in conflict with each other, arbitrates the demands to find a compromise or to give priority to one of them over the other.

The mode of operation of the brake system is as follows:

In brake circuit II, the valves 20, 21, 27, 28, 40 and 45 assume the position shown prior to onset of braking. The brake pressure generated in the master brake cylinder 2 can now become operative through the brake line 12 and the inlet lines 13 and 14 in the wheel brakes 15 and 16 of the driven rear axle.

If the wheels assigned to the brake circuit develop excessive brake slip and thus are prone to locking up, the controller 50 initiates the brake pressure modulation at the wheel brakes 15 and 16. To this end, the controller 50 switches one or both of the two-position valves 20 and 27 in the inlet lines 13 and 14 into the blocking position and sets the shut-off valve 40 to allow only a reduced flow rate from the master brake cylinder 2 to the inlet valves 20 and 27.

Subsequently, if a reduction in brake pressure is required, the electronic controller switches one or both of the two-position valves 21 and 28 in the return lines 22 and 29 into their open position. At the same time, the controller 50 starts the pump. In this phase of pressure reduction in at least one of the wheel brakes 15 and 16, pressure fluid can flow through the return line 33 into the low-pressure accumulator 34 or to the self-priming pump 35, which pumps it back into the brake line 12. The phase of pressure reduction is adjoined by phases for pressure holding and pressure build-up in the wheel brakes 15 and 16, until stable rotational behavior of the wheels of the brake circuit is attained. At the end of an anti-lock control operation, the controller 50 switches the drive motor 36 off, after the evacuation of the low-pressure accumulator 34. All valves return into their currentless positions as shown. This includes the shut-off valve 40, which returns to its open position allowing unrestricted flow of pressure fluid.

If a specific driving situation requires an active brake intervention to slow down a vehicle wheel, for example the wheel associated with wheel brake 16, the controller 50 switches the shut-off valve 40 in the brake line 12 into the blocking position, the switch-over valve 45 into its open position, and the inlet valve 20 in the inlet line 13 into the closed position. The controller 50 also switches on the self-priming pump 35, so that it can take in fluid from the pressure fluid reservoir 3 through the unactuated master brake cylinder 2, the brake line 12 and the bypass line 44 and can pump it into the wheel brake 16 through the pressure line 38, the brake line 12 and the inlet line 14. Pressure fluid pumping into the wheel brake 15 does not occur in this process, because the inlet valve 20 assumes its blocking position.

Should the driver of the vehicle desire to slow down the vehicle by depressing the brake pedal, pressure is built up in the master brake cylinder 2. The pressure sensor 41 detects this pressure coming from the master brake cylinder 2 and provides corresponding information to the electronic controller 50. The electronic controller 50 immediately opens the shut-off valve 40 in order to allow the master brake cylinder pressure to progress to the wheel brakes 15 and 16.

While the present invention has been explained on a hydraulic brake system including active brake control functions like traction control and/or electronic stability control, it can also be implemented in a brake system only capable of anti-lock brake control with a non-self-priming pump and without the bypass line 44 and the switch-over valve 45.

What is claimed is:

1. A hydraulic brake system with brake slip control, the system including a master brake cylinder (2) which is connected to a pressure fluid reservoir (3), at least one wheel brake (15, 16), a brake line (12, 13, 14) from the master brake cylinder (2) to the wheel brake (15, 16), an inlet valve (20,27) in the brake line (13, 14), a low-pressure accumulator (34), a return line (22, 29, 33) from the wheel brake cylinder (15,16) to the low-pressure accumulator (34), an outlet valve (21, 28) in the return line (22,29), a hydraulic pump (35) with an inlet side and a pressure side, a shut-off valve (40) in the brake line (12) between the master brake cylinder (2) and the inlet valve (20,27), a pressure line from the pressure side of the hydraulic pump (35) to the brake line (12) between the shut-off valve (40) and the inlet valve, a suction line from the low-accumulator (34) to the inlet side of the hydraulic pump (35), wherein
the shut-off valve (40) has an analog functionality capable of controlling the flow rate of fluid passing through the shut-off valve.

2. The brake system according to claim 1, wherein the analog functionality of the shut-off valve is accomplished by adjusting the cross-section of an opening inside the shut-off valve.

3. The brake system according to claim 1, wherein the analog functionality of the shut-off valve is accomplished by pulse-width modulation of a digital, electromagnetically operated NO valve.

4. The brake system according to claim 1, wherein the inlet valve is a digital, electromagnetically operated NO valve with only an open position and a closed position.

5. The brake system according to claim 1, which comprises an electronic controller (50) and is also capable of performing an active brake intervention, during which the shut-off valve (40) is closed, wherein the electronic controller (50) is programmed to open the shut-off valve (40) if the master brake cylinder (2) is actuated during an active brake intervention.
